(19) United States
(12) Patent Application Publication
(10) Pub. No.: US 2026/0307637 A1
(43) Pub. Date: Oct. 8, 2026

(54) System for Preserving Brake System Fluid Following a Disconnection Between Members of a Combination Vehicle

(71) Applicant: KB Intellectual Property GmbH & Co. KG, Pullach (DE)

(72) Inventors: Ryan S. Hurley, Lakewood, OH (US); Randy J. Salvatora, Columbia Station, OH (US)

(21) Appl. No.: 19/173,064

(22) Filed: Apr. 8, 2025

(51) Int. Cl. B60T 17/18; B60T 15/36

(52) U.S. Cl. CPC B60T 17/18; B60T 15/36

(57) ABSTRACT

A system for preserving fluid in a fluid source on a towing member of a combination vehicle following disconnection between the towing member and a towed member includes a control valve defining a supply port in communication with the fluid source and a delivery port in communication with a supply conduit that extends between the towing and towed members. A first trim element in the control valve moves, responsive to a differential pressure between fluid pressures at the supply and delivery ports, from an open position allowing delivery of fluid from the supply port to the delivery port to a closed position prohibiting fluid delivery. A second trim element in the control valve or a separate inversion valve reduces fluid pressure at the delivery port following the disconnection to cause movement of the first trim element from the open position to the closed position.

### BACKGROUND OF THE INVENTION

### a. Field of the Invention

This disclosure relates to a system for preserving fluid in a fluid source on a towing member of a combination vehicle following a disconnection between the towing member and a towed member of the combination vehicle. In particular, this disclosure relates to a system that accelerates closure of a fluid path from the fluid source to the towed member following the disconnection.

### b. Background Art

Conventional combination vehicles with fluid controlled braking systems transmit fluid from a towing member or power unit of the combination vehicle to a towed member of the combination vehicle along two different lines or conduits. One of the conduits, the supply conduit (commonly red in color), is used to transmit fluid from one or more fluid reservoirs on the towing member to (i) fluid reservoirs on the towed member for subsequent use in applying service brakes formed in wheel brakes on the towed member and actuating other fluid-controlled accessories on the towed member and (ii) fluid chambers in the wheel brakes for use in releasing parking brakes formed in the wheel brakes. The other conduit, the control conduit or service conduit (commonly blue in color), is used to transmit a fluid signal that causes application of the service brakes in the wheel brakes of the towed member in an amount proportional to the fluid signal.

During a disconnection between the towing member and the towed member (e.g., when a rupture occurs in one of the conduits between the towing member and towed member or when the towing member is not coupled to any towed members (i.e., is operating in a bobtail configuration)), any fluid transmitted to the conduits will be exhausted to atmosphere. The loss of this fluid decreases available fluid in the towing vehicle, leading to increased operation of fluid accumulation components (e.g., compressors, air treatment systems) and potential reductions in brake performance on the towing vehicle. The loss of fluid also increases the likelihood that parking or emergency brakes formed in wheel brakes on the towing member will be automatically applied mechanically due to low pressures. For these reasons, conventional combination vehicles include various systems that are intended to prevent discharge of fluid through the conduits during a disconnection between the towing member and the towed member. For example, control valves that control transmission of fluid from a fluid source on the towed member to the supply conduit may be configured such that a trim element in the valve moves from an open position permitting fluid flow from the fluid source to the supply conduit to a closed position prohibiting fluid flow if fluid pressure in the supply conduit drops and a differential pressure between fluid pressures in the fluid source and the supply conduit exceeds a threshold. Some towing members, however, are configured in such a way that a relatively large fluid volume exists between the control valve and the supply conduit and/or have fittings or other components that restrict the speed at which fluid flows from the control valve to the supply conduit. As a result, the differential pressure in the control valve between the fluid source and the supply conduit increases relatively slowly following any disconnection between the towing and towed members of the combination vehicle and the control valve will remain open for a relatively long period of time leading to significant fluid loss from the fluid source.

The inventors herein have recognized a need for a system for preserving fluid in a fluid source on a towing member of a combination vehicle following a disconnection between the towing member and a towed member of the combination vehicle that will minimize and/or eliminate one or more of the above-identified deficiencies.

### BRIEF SUMMARY OF THE INVENTION

This disclosure relates to a system for preserving fluid in a fluid source on a towing member of a combination vehicle following a disconnection between the towing member and a towed member of the combination vehicle. In particular, this disclosure relates to a system that accelerates closure of a fluid path from the fluid source to the towed member following the disconnection.

An embodiment of a system for preserving fluid in a fluid source on a towing member of a combination vehicle following a disconnection between the towing member and a towed member of the combination vehicle includes a control valve including a valve housing defining a supply port in communication with the fluid source and a delivery port in communication with a supply conduit that extends between the towing member and the towed member and is configured to transmit fluid from the towing member to the towed member. The control valve further includes a trim element configured for movement, responsive to a differential pressure between a fluid pressure at the supply port and a fluid pressure at the delivery port, from an open position in which fluid at the supply port is delivered to the delivery port to a closed position in which fluid at the supply port is not delivered to the delivery port. The system further includes means for reducing fluid pressure at the delivery port of the control valve following the disconnection between the towing member and the towed member of the combination vehicle to thereby cause movement of the first trim element from the open position to the closed position.

Another embodiment of a system for preserving fluid in a fluid source on a towing member of a combination vehicle following a disconnection between the towing member and a towed member of the combination vehicle includes a control valve including a valve housing defining a supply port in communication with the fluid source, a delivery port in communication with a supply conduit that extends between the towing member and the towed member and is configured to transmit fluid from the towing member to the towed member, and an exhaust port. The control valve further includes a first trim element configured for movement, responsive to a differential pressure between a fluid pressure at the supply port and a fluid pressure at the delivery port, from an open position in which fluid at the supply port is delivered to the delivery port to a closed position in which fluid at the supply port is not delivered to the delivery port. The control valve further includes a second trim element configured to assume a closed position if fluid pressure at the delivery port meets a predetermined condition relative to a threshold pressure and an open position connecting the delivery port and the exhaust port if the fluid pressure at the delivery port does not meet the predetermined condition relative to the threshold pressure to thereby reduce fluid pressure at the delivery port to cause movement of the first trim element from the open position to the closed position.

Another embodiment of a system for preserving fluid in a fluid source on a towing member of a combination vehicle following a disconnection between the towing member and a towed member of the combination vehicle includes a control valve including a valve housing defining a supply port in communication with the fluid source and a delivery port in communication with a supply conduit that extends between the towing member and the towed member and is configured to transmit fluid from the towing member to the towed member. The control valve further includes a first trim element configured for movement, responsive to a differential pressure between a fluid pressure at the supply port and a fluid pressure at the delivery port, from an open position in which fluid at the supply port is delivered to the delivery port to a closed position in which fluid at the supply port is not delivered to the delivery port. The system further includes an inversion valve including a valve housing defining a supply port in communication with the supply conduit and the delivery port of the control valve and a delivery port open to atmosphere. The inversion valve further includes a second trim element configured to assume a closed position if fluid pressure at the delivery port of the control valve meets a predetermined condition relative to a threshold pressure and an open position connecting the supply port of the inversion valve and the delivery port of the inversion valve if the fluid pressure at the delivery port of the control valve does not meet the predetermined condition relative to the threshold pressure to thereby reduce fluid pressure at the delivery port of the control valve to cause movement of the first trim element of the control valve from the open position to the closed position.

A system for preserving fluid in a fluid source on a towing member of a combination vehicle following a disconnection between the towing member and a towed member of the combination vehicle in accordance with the teachings disclosed herein is advantageous relative to conventional systems. During a disconnection between the towing member and towed member, the system accelerates a decrease in fluid pressure at a delivery port of a control valve that controls delivery of fluid from the fluid source to a supply conduit extending between the towing and towed members. By accelerating the decrease in fluid pressure at the delivery port of the control valve, the differential pressure between the supply port of the control valve in communication with the fluid source and the delivery port of the control valve in communication with the supply conduit increases more rapidly leading to more rapid closure of the control valve. In combination vehicles having a relatively large fluid volume between the control valve and the supply conduit and/or having fittings or other components that restrict the speed at which fluid flows between the control valve and the supply conduit, faster closure of the control valve will prevent significant fluid loss from the fluid source that might otherwise occur. As a result, fluid accumulation components (e.g., compressors, air treatment systems) operate less frequently, braking performance on the towing member is preserved, and the likelihood that parking brakes formed in wheel brakes on the towing member will be automatically applied mechanically due to low fluid pressure is reduced.

The foregoing and other aspects, features, details, utilities, and advantages of the present teachings will be apparent from reading the following description and claims, and from reviewing the accompanying drawings.

### BRIEF DESCRIPTION OF THE DRAWINGS

FIG. 1 is a diagrammatic view of a combination vehicle.

FIG. 2 is a diagrammatic view of a portion of a brake control system for the combination vehicle of FIG. 1 illustrating one embodiment of a system for preserving fluid in a fluid source on a towing member of a combination vehicle following a disconnection between the towing member and a towed member of the combination vehicle.

FIG. 3 is a diagrammatic view of a portion of a brake control system for the combination vehicle of FIG. 1 illustrating another embodiment of a system for preserving fluid in a fluid source on a towing member of a combination vehicle following a disconnection between the towing member and a towed member of the combination vehicle.

FIG. 4 is a diagrammatic view of a portion of a brake control system for the combination vehicle of FIG. 1 illustrating another embodiment of a system for preserving fluid in a fluid source on a towing member of a combination vehicle following a disconnection between the towing member and a towed member of the combination vehicle.

### DETAILED DESCRIPTION OF THE INVENTION

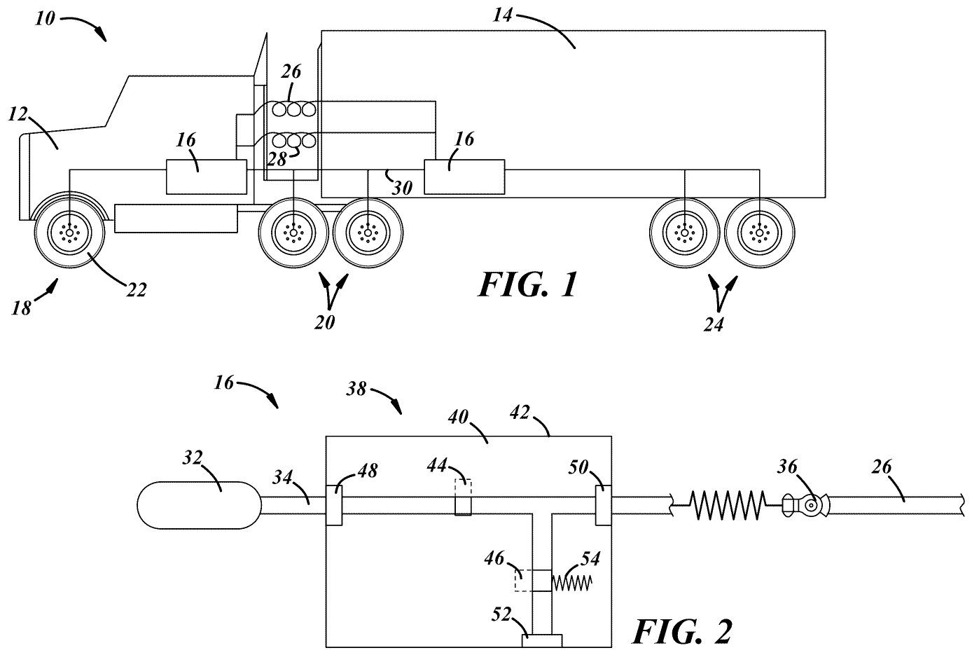

Referring now to the drawings wherein like reference numerals are used to identify identical components in the various views, FIG. 1 illustrates a combination vehicle 10. In the illustrated embodiment, vehicle 10 comprises a commercial vehicle and, in particular, a tractor-trailer. It should be understood, however, that the systems and methods disclosed herein may find application on other types of commercial and non-commercial combination vehicles. Vehicle 10 includes a towing member 12 (e.g., a tractor) and one or more towed members 14 (e.g., a semi-trailer, dolly, or other towed vehicle type). Vehicle 10 also includes a brake control system 16 for slowing, stopping and/or preventing movement of vehicle 10.

Towing member 12 provides power for moving towed member 14. Towing member 12 includes steering and drive axles 18, 20 each of which support one or more wheels 22 at either end. Towing member 12 further includes a power unit, such as an internal combustion engine or electric motor for generating mechanical energy used to rotate the wheels and a battery that provides electrical energy for use in starting the power unit and, in embodiments where the power unit includes an electric motor, for use by the power unit in generating the mechanical energy used to drive the wheels. The battery may also provide power to various accessory systems on vehicle 10.

Towed member 14 is detachably coupled to towing member 12. In the illustrated embodiment, towed member 14 comprises a semi-trailer configured to carry or store freight, but it should be understood that towed member 14 may assume other forms including, for example, a full trailer or dolly. Further, although a single towed member 14 is shown in the illustrated embodiment, it should be understood that the number of towed members attached to towing member 12 may vary. Towed member 14 is supported on one or more trailer axles 24, each of which may support one or more wheels 22 at either end.

Brake control system 16 is provided to brake wheels 22 on towing member 12 and towed member 14 to slow, stop or prevent movement of vehicle 10. System 16 may include components on both towing member 12 and towed member 14 that may be in fluid and/or electrical communication using conventional fluid hoses or conduits 26, 28 and electrical conductors 30 extending between towing member 12 and towed member 14. Conduit 26, referred to herein as supply conduit 26 and typically red in color, is used to transmit fluid from one or more fluid reservoirs on towing member 12 to (i) fluid reservoirs on towed member 14 for subsequent use in applying service brakes formed in wheel brakes associated with wheels 22 of trailer axles 24 of towed member 14 and actuating other fluid-controlled accessories on towed member 14 and (ii) fluid chambers in the wheel brakes for use in releasing parking brakes formed in the wheel brakes. The other conduit 28, referred to herein as the control conduit or service conduit 28 and typically blue in color, is used to transmit a fluid signal that causes application of the service brakes in the wheel brakes associated with wheels 22 of trailer axles 24 of towed member 14 in an amount proportional to the fluid signal. As discussed in greater detail below, brake control system 16 includes a system for preserving fluid in a fluid source on towing member 12 following a disconnection between towing member 12 and towed member 14 (e.g., when a rupture occurs in conduit 26 or when towing member 12 is not coupled to towed member 14 (i.e., is operating in a bobtail configuration)). Electrical conductors 30 allow for the exchange of messages (data or commands) between components of brake control system 16 on towing member 12 and towed member 14. Conductors 30 may, for example, form a portion of vehicle communications bus implementing a communications network such as a controller area network (CAN) or local interconnect network (LIN) or power line carrier communication (PLC) in accordance with various industry standard protocols including by not limited to SAE J1939, SAE J1922, and SAE J2497 or using a proprietary protocol.

Referring now to FIG. 2, selected components of brake control system 16 on towing member 12 are illustrated including a fluid source 32, fluid conduits 34, a gladhand connector 36 and one embodiment of a system 38 for preserving fluid in fluid source 32 following a disconnection between towing member 12 and towed member 14. It should be understood that brake control system 16 will include a number of additional components that are not illustrated herein including wheel brakes that apply a braking force to one more wheels 22 on vehicle 10 (for service braking and/or emergency or parking braking and to maintain compliance with local regulations), additional elements of a fluid circuit that generates fluid pressure within brake control system 16 and controls the delivery of fluid to the actuator of each wheel brake including compressors and air treatment modules and various valves and valve modules, sensors that identify various conditions associated with vehicle 10 and the surrounding environment that impact braking of vehicle 10 (e.g., wheel speed sensors, steer angle sensors, yaw rate sensors, load sensors, pressure sensors, etc.) and electronic controllers that control the operation of various electromechanical valve and valve modules in the fluid circuit in order to control the fluid pressure delivered to the wheel brakes and, therefore, the braking force applied to the wheels 22 on axles 18, 20 and 24.

Fluid source 32 stores compressed fluid that is generated by a compressor (not shown) and treated by an air treatment module (not shown) to remove solid, liquid and vapor contaminants from the compressed fluid. Although a single fluid source is shown in the illustrated embodiment, it should be understood that brake control system 16 may include multiple fluid sources. The compressed fluid is used to apply and release wheel brakes associated with wheels 22 on axles 18, 20 and 24 in brake control system 16. In the illustrated embodiment, fluid source 32 supplies pressurized fluid to towed member 14 through supply conduit 26 to (i) pressurize fluid reservoirs on towed member 14 for use in applying service brakes formed in wheel brakes on towed member 14 and actuating other fluid-controlled accessories on towed member 14 and (ii) deliver fluid to fluid chambers in the wheel brakes on towed member 14 for use in releasing the parking brake portion of the wheel brakes. Fluid source 32 also supplies pressurized fluid to wheel brakes on towing member 12 for use in applying service brakes and releasing parking brakes in the wheel brakes on towing member 12. Therefore, a loss of fluid from fluid source 32 through supply conduit 26 resulting from a disconnection between towing member 12 and towed member 14 may result in a reduction in brake performance on towing member 12. A loss of fluid from fluid source 32 may also cause an undesirable increase in the of operation of fluid accumulation components (e.g., compressors, air treatment systems) and increase the likelihood that parking brakes formed in wheel brakes on towing member 12 will be automatically applied mechanically due to low fluid pressure.

Fluid conduits 34 are used to transport fluid between fluid source 32, glad-hand connector 36, system 38, and other components in the fluid circuit of brake control system 16 that are not illustrated herein. Conduits 34 may be made from conventional metals and/or plastics and have connectors at either end configured to join the conduits 34 to corresponding components of the fluid circuit.

Gladhand connector 36 is used to connect supply conduit 26 to towing member 12. Similar gladhand connectors (not shown) connect supply conduit 26 to towed member 14 and control conduit 28 to towing member 12 and towed member 14. Supply pressure travels from towing member 12 to towed member 14 through connector 36, supply conduit 26, and a corresponding connector on towed member 14 for use in charging fluid reservoirs on towed member 14 and releasing parking brakes in the wheel brakes for the wheels 22 on trailer axles 24.

System 38 is provided to preserve fluid in fluid source 32 following a disconnection between towing member 12 and towed member 14 and is implemented in a control valve 40 that controls the delivery of fluid from fluid source 32 to supply conduit 26. Although control valve 40 receives fluid directly from fluid source 32 and provides fluid directly to glad-hand connector 36 and supply conduit 26 in the illustrated embodiment, it should be understood that additional valves within brake control system 16 may be positioned between fluid source 32 and control valve 40 and between control valve 40 and gladhand connector 36 to provide various functions within brake control system 16. It should also be understood that control valve 40 may receive fluid from additional fluid sources other than fluid source 32 and that system 38 may, therefore, preserve fluid in those additional fluid sources as well as fluid source 32. Control valve 40 includes a valve housing 42 and a trim element 44 that controls the flow of fluid within control valve 40. In accordance with one aspect of the systems disclosed herein, control valve 40 further includes means, such as a trim element 46, for reducing fluid pressure at a delivery port 50 of control valve 40 following a disconnection between towing member 12 and towed member 14.

Valve housing 42 defines a set of fluid pathways between various ports formed in valve housing 42. Valve housing 42 also positions and orients the other components of control valve 40 and protects those components from foreign objects and elements. In the illustrated embodiment, housing 42 defines a supply port 48, a delivery port 50 and an exhaust port 52. It should be understood, however, that housing 42 may include additional supply, delivery, and/or exhaust ports. Supply port 48 is in communication (directly or indirectly) with fluid source 32. Delivery port 50 is in communication (directly or indirectly) with supply conduit 26. Exhaust port 52 is open to atmosphere.

Trim element 44 controls the delivery of fluid between supply port 48 and delivery port 50. Trim element 44 may comprise a piston or similar structure that moves responsive to fluid pressure within control valve 40. In accordance with one aspect of the systems disclosed herein, trim element 44 is configured for movement from an open position (diagrammatically illustrated in dotted lines in FIG. 2) in which fluid at supply port 48 is delivered to delivery port 50 to a closed position (diagrammatically illustrated in solid lines in FIG. 2) in which fluid at supply port 48 is not delivered to delivery port 50. Trim element 44 moves between the open and closed positions responsive to a pressure differential between a fluid pressure at supply port 48 and a fluid pressure at delivery port 50. The configuration of trim element 44 and the fluid passageways in valve housing 42 establish an effective orifice that limits fluid flow from the supply side of trim element 44 to the delivery side of trim element 44. Following a disconnection between towing member 12 and towed member 14, fluid pressure in supply conduit 26 and, as a result, at delivery port 50 will begin to decrease. Because of the fluid flow restriction established by the orifice, the replenishment of delivery side air is effectively reduced. This action increases a differential pressure between fluid pressure on the supply side of trim element 44 in communication with supply port 48 and the delivery side of trim element 44 in communication with delivery port 50. Control valve 40 is configured through, for example, the configuration of trim element 44 and/or the fluid passageways formed in valve housing 42 such that the increasing differential pressure causes trim element 44 to move from the open position to the closed position terminating further delivery of fluid from fluid source 32 to supply conduit 26. Those of skill in the art will understand that the configuration of valve housing 42 and trim element 44 may be varied to achieve this functionality. Trim element 44 may, for example, be configured to define surfaces against which fluid pressure on the supply and delivery sides of trim element 44 will act to cause movement of trim element 44 that is dependent on the differential pressure in fluid pressure on each side of trim element 44. In addition to fluid pressure forces acting on trim element 44, other forces may be applied to trim element 44 to move or position trim element 44 depending on the configuration of control valve 40. For example, a spring (not shown) may apply a force urging trim element 44 away from the open position and towards the closed position in certain embodiments.

Trim element 46 controls the delivery of fluid between delivery port 50 and exhaust port 52 and provides a means for reducing fluid pressure at delivery port 50 following a disconnection between towing member 12 and towed member 14. Trim element 46 may comprise a piston or similar structure that moves responsive to fluid pressure within control valve 40. Trim element 46 is configured to move between a closed position (diagrammatically shown in solid lines in FIG. 2) preventing fluid communication between delivery port 50 and exhaust port 52 and an open position (diagrammatically shown in dotted lines in FIG. 2) allowing fluid communication between delivery port 50 and exhaust port 52. Trim element 46 is configured to assume the closed position if fluid pressure at delivery port 50 meets a predetermined condition relative to a threshold pressure (e.g., is greater than the threshold pressure) closing the fluid path between delivery port 50 and exhaust port 52 in control valve 40. Trim element 46 is configured to assume an open position connecting delivery port 50 and exhaust port 52 in control valve 40 if the fluid pressure at delivery port 50 does not meet the predetermined condition relative to the threshold pressure (e.g., is less than or equal to the threshold pressure). Trim element 46 may, for example, be biased towards the open position by means, such as a spring 54 (e.g., a metal or composite spring) or another mechanism (e.g., air), for applying a spring force corresponding to the threshold pressure. Fluid pressure at delivery port 50 overcomes the spring force to move trim element 46 to the closed position. When a disconnection between towing member 12 and towed member 14 occurs, the fluid pressure in supply conduit 26 and at delivery port 50 will begin to fall. Once the fluid pressure reaches the threshold pressure, the spring force will cause trim element 46 to move to the open position connecting delivery port 50 and exhaust port 52 and venting fluid from the fluid path leading to supply conduit 26 through delivery port 50 thereby reducing the fluid pressure at delivery port 50. By reducing the fluid pressure at delivery port 50 following the disconnection, trim element 46 accelerates the increase in the differential pressure between the supply and delivery sides of trim element 44 thereby accelerating movement of trim element 44 from the open position to the closed position and preserving fluid in fluid source 32. The threshold pressure at which trim element 46 moves from the closed position to the open position may be varied, but is preferably established a level that is lower than the anticipated fluid pressure present when supplying fluid from fluid source 32 to fluid reservoirs on towed member 14 and/or brake chambers of the wheel brakes in towed member 14 (such that normal operation of the supply conduit 26 is not compromised), but high enough such that trim element 46 will move to an open position as quickly as possible following a disconnection between towing member 12 and towed member 14 and a resulting decrease in fluid pressure in supply conduit 26 and at delivery port 50.

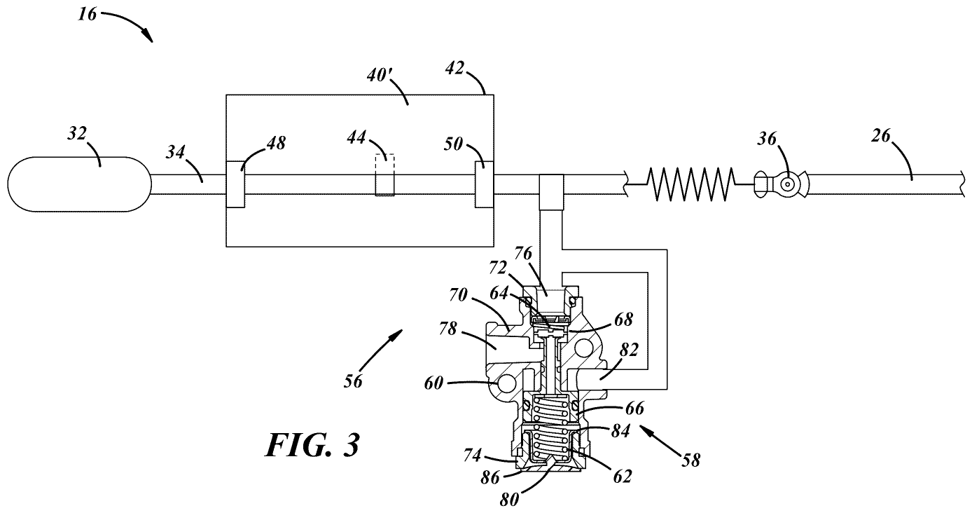

Referring now to FIG. 3, selected components of brake control system 16 on towing member 12 are illustrated including a fluid source 32, fluid conduits 34, a gladhand connector 36 and another embodiment of a system 56 for preserving fluid in fluid source 32 following a disconnection between towing member 12 and towed member 14. System 56 is similar to system 38 (FIG. 2) and a description of like components may be found hereinabove. System 56 differs from system 38 in the configuration of control valve 40′ and the addition of an inversion valve 58 which provides a different means for reducing fluid pressure and at delivery port 50 of control valve 40′ following a disconnection between towing member 12 and towed member 14.

Control valve 40′ controls delivery of fluid from fluid source 32 to supply conduit 26. Control valve 40′ is similar to control valve 40 (FIG. 2) and a description of similar components may be found hereinabove. Control valve 40′ may differ from control valve 40′ in that control valve 40′ may omit the exhaust port 54 found in valve housing 42 of control valve 40, trim element 46 and spring 54.

Inversion valve 58 provides another means for reducing fluid pressure at delivery port 50 of control valve 40′ following a disconnection between towing member 12 and towed member 14. Inversion valve 58 may comprise the valve offered for sale by Bendix Commercial Vehicle Systems LLC under the trademark “TR-3”. Inversion valve 58 includes a valve housing 60, springs 62, 64, and trim elements 66, 68.

Valve housing 60 defines a set of fluid pathways between ports formed in valve housing 60. Valve housing 60 also positions and orients the other components of inversion valve 58 and protects those components from foreign objects and elements. Valve housing 60 may include multiple housing members 70, 72, 74. Housing member 70 defines a supply port 76, a delivery port 78, an exhaust port 80 and a control port 82 and fluid passageways between ports 76, 78, 80, 82. Supply port 76 and control port 82 are in communication with supply conduit 26 and delivery port 50 of control valve 40′. Delivery port 78 and exhaust port 80 are open to atmosphere. Housing members 72, 74 are disposed within supply port 76 and exhaust port 80, respectively, and position and maintain the position of certain components within inversion valve 58. In particular, housing member 72 defines a spring seat configured to engage one end of spring 62. Housing member 74 is configured to support a retainer 84 that holds a diaphragm 86 and that defines a spring seat configured to engage one end of spring 64. Members 72, 74 each include a plurality of threads on an outer surface configured to engage corresponding threads on internal surfaces of housing member 70 proximate supply port 76 and exhaust port 80 to secure housing members 72, 74 within supply port 76 and exhaust port 80 of housing member 70. Housing members 72, 74 are cylindrical in shape to allow fluid flow therethrough.

Springs 62, 64, bias trim elements 66, 68, respectively, towards selected positions within valve housing 60. Spring 62 is seated between retainer 84 and trim element 66. Spring 64 is seated between one end of housing member 72 and one side of trim element 68.

Trim element 66 is disposed within housing member 70 of valve housing 60 and may comprise a piston that is cylindrical in shape. Trim element 66 is movable between a closed position in which trim element 66 prevents delivery of fluid from delivery port 78 to exhaust port 80 and an open position in which trim element 66 allows delivery of fluid from delivery port 78 to exhaust port 80. One end of trim element 66 defines a spring seat for spring 62 opposing the spring seat in retainer 84 and trim element 66 is biased towards the open position by spring 62. The opposite end of trim element 66 is configured for engagement with trim element 68.

Trim element 68 is also disposed within housing member 70 of valve housing 60 and is movable between a closed position in which trim element 68 prevents delivery of fluid from supply port 76 to delivery port 78 and an open position in which trim element 68 allows delivery of fluid from supply port 76 to delivery port 78. One side of trim element 68 defines a spring seat for spring 64 opposing the spring seat in housing member 72 and trim element 68 is biased towards the closed position by spring 64. The opposite side of trim element 68 is configured for engagement with trim element 66.

As noted above, control port 82 in valve housing 60 is in communication with supply conduit 26 and delivery port 50 of valve 40′. Fluid pressure at control port 82 controls the position of trim elements 66 and 68. A relatively high fluid pressure at control port 82 urges trim element 66 away from trim element 68 against the force of spring 62 allowing spring 64 to move trim element 68 to a closed position and preventing delivery of fluid from supply port 76 to delivery port 78. A relatively low fluid pressure at control port 82 is unable to overcome the force of spring 62. As a result, spring 62 urges trim element 66 against trim element 68 and moving trim element 68 against the force of spring 64 to an open position and allowing delivery of fluid from supply port 76 to delivery port 78 and atmosphere. Trim element 68 is therefore configured to assume a closed position if fluid pressure at delivery port 50 of control valve 40′ and, therefore, at control port 82, meets a predetermined condition relative to a threshold pressure (e.g., is greater than the threshold pressure) closing the fluid path between supply port 76 and delivery port 78 in inversion valve 58. Trim element 68 is configured to assume an open position connecting supply port 76 and delivery port 78 in inversion valve 58 if the fluid pressure at delivery port 50 of control valve 40′ and, therefore, at control port 82 does not meet the predetermined condition relative to the threshold pressure (e.g., is less than or equal to the threshold pressure). Spring 62 exerts a force corresponding to the threshold pressure. A relatively high fluid pressure at control port 82 overcomes the force of spring 62, allowing spring 64 to move trim element 68 to the closed position. When a disconnection between towing member 12 and towed member 14 occurs, the fluid pressure at control port 82 will begin to fall. Once the fluid pressure reaches the threshold pressure, spring 62 will cause trim element 68 to move to the open position (through movement of trim element 66) connecting supply port 76 and delivery port 78 and venting fluid from the passages between delivery port 50 of control valve 40′ and supply conduit 26 through delivery port 78 of inversion valve 58 thereby reducing the fluid pressure at delivery port 50 of control valve 40′. By reducing the fluid pressure at delivery port 50 of control valve 40′ following the disconnection, trim element 68 accelerates the increase in the differential pressure between the supply and delivery sides of trim element 44 in control valve 40′ thereby accelerating movement of trim element 44 from the open position to the closed position and preserving fluid in fluid source 32. The threshold pressure at which trim element 68 moves from the closed position to the open position may be varied, but is preferably established a level that is lower than the anticipated fluid pressure present when supplying fluid from fluid source 32 to fluid reservoirs on towed member 14 and/or brake chambers of the wheel brakes in towed member 14 (such that normal operation of the supply conduit 26 is not compromised), but high enough such that trim element 68 will move to an open position as quickly as possible following a disconnection between towing member 12 and towed member 14 and a resulting decrease in fluid pressure in supply conduit 26 and at delivery port 50 of control valve 40′.

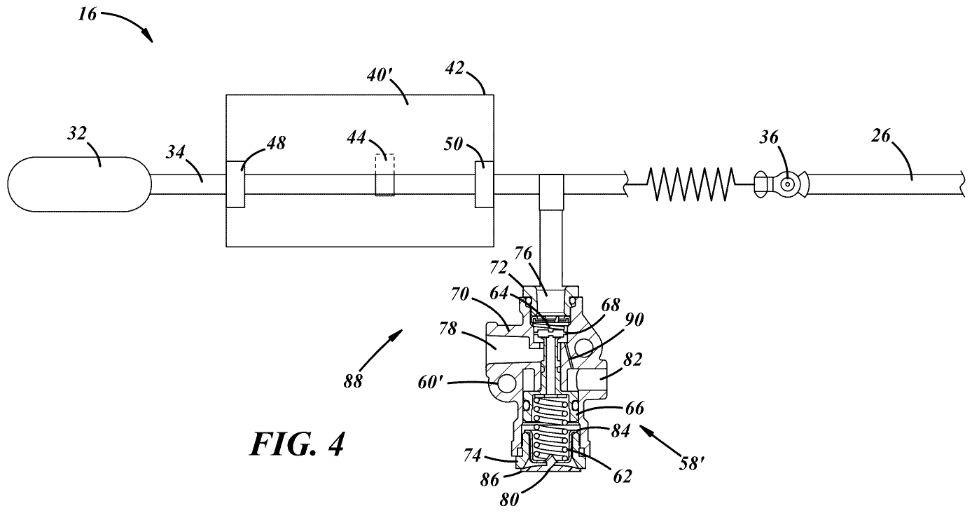

Referring now to FIG. 4, selected components of brake control system 16 on towing member 12 are illustrated including a fluid source 32, fluid conduits 34, a gladhand connector 36 and another embodiment of a system 88 for preserving fluid in fluid source 32 following a disconnection between towing member 12 and towed member 14. System 88 is similar to system 56 (FIG. 3) and a description of like components may be found hereinabove. System 88 differs from system 56 in the configuration of inversion valve 58′ which provides another means for reducing fluid pressure at delivery port 50 of control valve 40′ following a disconnection between towing member 12 and towed member 14.

Inversion valve 58′ provides another means for reducing fluid pressure at delivery port 50 of control valve 40′ following a disconnection between towing member 12 and towed member 14. Inversion valve 58′ may comprise the valve offered for sale by Bendix Commercial Vehicle Systems LLC under the trademark “TR-3”, but with internal bleed control. Inversion valve 58′ is substantially similar to inversion valve 58 in system 56, but includes a valve housing 60′ with a different configuration than the valve housing 60 in inversion valve 58 of system 56. Valve housing 60′ of inversion valve 58′ is substantially similar to valve housing 60 of inversion valve 58 described hereinabove, but includes an internal passageway 90 placing supply port 76 and control port 82 in communication. A plug (not shown) is also inserted into control port 82. Because supply port 76 and control port 82 are in communication with one another, the fluid pressure at control port 82 equals the fluid pressure at supply port 76. A relatively high fluid pressure at support port 76, and at delivery port 50 of control valve 40′, overcomes the force of spring 62 allowing spring 64 to move trim element 68 to the closed position. When a disconnection between towing member 12 and towed member 14 occurs, the fluid pressure at delivery port 50 of control valve ′40, supply port 76 and control port 82 will begin to fall. Once the fluid pressure reaches the threshold pressure, spring 62 will cause trim element 68 to move to the open position (through movement of trim element 66) connecting supply port 76 and delivery port 78 of inversion valve 58′ and venting fluid from the passages between delivery port 50 of control valve 40′ and supply conduit 26 through delivery port 78 of inversion valve 58 thereby reducing the fluid pressure at delivery port 50 of control valve 40′. By reducing the fluid pressure at delivery port 50 of control valve 40′ following the disconnection, trim element 68 accelerates the increase in the differential pressure between the supply and delivery sides of trim element 44 in control valve 40′ thereby accelerating movement of trim element 44 from the open position to the closed position and preserving fluid in fluid source 32. The threshold pressure at which trim element 68 moves from the closed position to the open position may be varied, but is preferably established a level that is lower than the anticipated fluid pressure present when supplying fluid from fluid source 32 to fluid reservoirs on towed member 14 and/or brake chambers of the wheel brakes in towed member 14 (such that normal operation of the supply conduit 26 is not compromised), but high enough such that trim element 68 will move to an open position as quickly as possible following a disconnection between towing member 12 and towed member 14 and a resulting decrease in fluid pressure in supply conduit 26 and at delivery port 50 of control valve 40′.

A system 38, 56 or 88 for preserving fluid in a fluid source 32 on a towing member 12 of a combination vehicle 10 following a disconnection between the towing member 12 and a towed member 14 of the combination vehicle 10 in accordance with the teachings disclosed herein is advantageous relative to conventional systems. During a disconnection between the towing member 12 and towed member 14, the system 38, 56 or 88 accelerates a decrease in fluid pressure at a delivery port 50 of a control valve 40 or 40′ that controls delivery of fluid from the fluid source 32 to a supply conduit 26 extending between the towing and towed members 12, 14. By accelerating the decrease in fluid pressure at the delivery port 50 of the control valve 40 or 40′, the differential pressure between the supply port 48 of the control valve 40 or 40′ in communication with the fluid source 32 and the delivery port 50 of the control valve 40 or 40′ in communication with the supply conduit 26 increases more rapidly leading to more rapid closure of the control valve 40 or 40′. In combination vehicles 10 having a relatively large fluid volume between the control valve 40 or 40′ and the supply conduit 26 and/or having fittings or other components that restrict the speed at which fluid flows between the control valve 40 or 40′ and the supply conduit 26, faster closure of the control valve 40 or 40′ will prevent significant fluid loss from the fluid source 32 that might otherwise occur. As a result, fluid accumulation components (e.g., compressors, air treatment systems) operate less frequently, braking performance on the towing member 12 is preserved, and the likelihood that parking brakes formed in wheel brakes on the towing member 12 will be automatically applied mechanically due to low fluid pressure is reduced.

While the invention has been shown and described with reference to one or more particular embodiments thereof, it will be understood by those of skill in the art that various changes and modifications can be made without departing from the spirit and scope of the invention.

What is claimed is:

1. A system for preserving fluid in a fluid source on a towing member of a combination vehicle following a disconnection between the towing member and a towed member of the combination vehicle, comprising:
a control valve including
a valve housing defining
a supply port in communication with the fluid source; and
a delivery port in communication with a supply conduit that extends between the towing member and the towed member and is configured to transmit fluid from the towing member to the towed member; and,
a first trim element configured for movement, responsive to a differential pressure between a fluid pressure at the supply port and a fluid pressure at the delivery port, from an open position in which fluid at the supply port is delivered to the delivery port to a closed position in which fluid at the supply port is not delivered to the delivery port; and,
means for reducing fluid pressure at the delivery port of the control valve following the disconnection between the towing member and the towed member of the combination vehicle to thereby cause movement of the first trim element from the open position to the closed position.

2. The system of claim 1 wherein the first trim element moves from the open position to the closed position due to an increase in the differential pressure between the fluid pressure at the supply port and the fluid pressure at the delivery port.

3. The system of claim 1 wherein the valve housing of the control valve defines an exhaust port and the means for reducing fluid pressure at the delivery port of the control valve includes a second trim element in the control valve configured to assume a closed position if fluid pressure at the delivery port meets a predetermined condition relative to a threshold pressure and an open position connecting the delivery port and the exhaust port if the fluid pressure at the delivery port does not meet the predetermined condition relative to the threshold pressure.

4. The system of claim 3 wherein the control valve includes means for applying a spring force urging the second trim element away from the open position and towards the closed position, the spring force corresponding to the threshold pressure.

5. The system of claim 1 wherein the means for reducing fluid pressure at the delivery port of the control valve includes an inversion valve including:
a valve housing defining
a supply port in communication with the supply conduit and the delivery port of the control valve; and,
a delivery port open to atmosphere; and,
a second trim element configured to assume a closed position if fluid pressure at the delivery port of the control valve meets a predetermined condition relative to a threshold pressure and an open position connecting the supply port of the inversion valve and the delivery port of the inversion valve if the fluid pressure at the delivery port of the control valve does not meet the predetermined condition relative to the threshold pressure.

6. The system of claim 5 wherein the inversion valve includes a spring applying a spring force urging the second trim element away from the open position and towards the closed position, the spring force corresponding to the threshold pressure.

7. The system of claim 5 wherein the valve housing of the inversion valve further includes a control port in communication with the supply conduit and the delivery port of the control valve and fluid pressure at the control port determines whether the second trim element assumes the closed position or the open position.

8. The system of claim 7 wherein the valve housing of the inversion valve defines a fluid passage between the supply port of the inversion valve and the control port of the inversion valve.

9. A system for preserving fluid in a fluid source on a towing member of a combination vehicle following a disconnection between the towing member and a towed member of the combination vehicle, comprising:
a control valve including
a valve housing defining
a supply port in communication with the fluid source; and
a delivery port in communication with a supply conduit that extends between the towing member and the towed member and is configured to transmit fluid from the towing member to the towed member; and,
an exhaust port;
a first trim element configured for movement, responsive to a differential pressure between a fluid pressure at the supply port and a fluid pressure at the delivery port, from an open position in which fluid at the supply port is delivered to the delivery port to a closed position in which fluid at the supply port is not delivered to the delivery port; and,
a second trim element configured to assume a closed position if fluid pressure at the delivery port meets a predetermined condition relative to a threshold pressure and an open position connecting the delivery port and the exhaust port if the fluid pressure at the delivery port does not meet the predetermined condition relative to the threshold pressure to thereby reduce fluid pressure at the delivery port to cause movement of the first trim element from the open position to the closed position.

10. The control valve of claim 9 wherein the first trim element moves from the open position to the closed position due to an increase in the differential pressure between the fluid pressure at the supply port and the fluid pressure at the delivery port.

11. The system of claim 9 wherein the control valve includes means for applying a spring force urging the second trim element away from the open position and towards the closed position, the spring force corresponding to the threshold pressure.

12. A system for preserving fluid in a fluid source on a towing member of a combination vehicle following a disconnection between the towing member and a towed member of the combination vehicle, comprising:
a control valve including
a valve housing defining
a supply port in communication with the fluid source; and
a delivery port in communication with a supply conduit that extends between the towing member and the towed member and is configured to transmit fluid from the towing member to the towed member; and,
a first trim element configured for movement, responsive to a differential pressure between a fluid pressure at the supply port and a fluid pressure at the delivery port, from an open position in which fluid at the supply port is delivered to the delivery port to a closed position in which fluid at the supply port is not delivered to the delivery port; and,
an inversion valve including
a valve housing defining
a supply port in communication with the supply conduit and the delivery port of the control valve; and,
a delivery port open to atmosphere; and,
a second trim element configured to assume a closed position if fluid pressure at the delivery port of the control valve meets a predetermined condition relative to a threshold pressure and an open position connecting the supply port of the inversion valve and the delivery port of the inversion valve if the fluid pressure at the delivery port of the control valve does not meet the predetermined condition relative to the threshold pressure to thereby reduce fluid pressure at the delivery port of the control valve to cause movement of the first trim element of the control valve from the open position to the closed position.

13. The system of claim 12 wherein the first trim element of the control valve moves from the open position to the closed position due to an increase between the pressure differential in the fluid pressure at the supply port of the control valve and the fluid pressure at the delivery port of the control valve.

14. The system of claim 12 wherein the inversion valve includes means for applying a spring force urging the second trim element away from the open position and towards the closed position, the spring force corresponding to the threshold pressure.

15. The system of claim 12 wherein the valve housing of the inversion valve further includes a control port in communication with the supply conduit and the delivery port of the control valve and fluid pressure at the control port determines whether the second trim element assumes the closed position or the open position.

16. The system of claim 15 wherein the valve housing of the inversion valve defines a fluid passage between the supply port of the inversion valve and the control port of the inversion valve.
